(19) United States
(12) Patent Application Publication
(10) Pub. No.: US 2026/0034533 A1
(43) Pub. Date: Feb. 5, 2026

(54) METHOD AND APPARATUS FOR CONTROLLING A MODIFICATION PROCESS OF HYGROSCOPIC MATERIAL

(71) Applicant: Avant Wood Oy, Kuopio (FI)

(72) Inventors: Pekka RITVANEN, Kuopio (FI); Jyrki LEHTINEN, Haukivuori (FI); Timo PASNEN, Kuopio (FI); Kari SAYNEVIRTA, Mikkeli (FI); Kari TERVO, Kuopio (FI)

(21) Appl. No.: 19/112,121

(22) PCT Filed: Sep. 14, 2022
(86) PCT No.: PCT/FI2022/050617

§ 371 Date: Mar. 14, 2025

(51) Int. Cl. B01J 20/30; B01D 53/26; B01J 20/22

(52) U.S. Cl. CPC B01J 20/3078; B01D 53/263; B01J 20/22; B01J 20/3035; B01J 2220/44; B01J 2220/4825

(57) ABSTRACT

Method and apparatus (10) for controlling a modification process of hygroscopic material (15) comprising method steps of: measuring at least one process variable from the modification process at least during the modification; measuring at least one process variable from the hygroscopic material at least during the modification; calculating at least one intermediate control parameter by a neural network busing at least the measured process variables as input parameters of the neural network; and controlling the modification process by using genetic algorithms and genetic programming based on the said at least one intermediate control parameter determined by the neural network.

### TECHNICAL FIELD

The invention relates to a method and apparatus for controlling a modification process, such as a thermomechanical modification process for example, of hygroscopic material.

### BACKGROUND

Hygroscopic materials are materials having ability to absorb and store moisture from the surrounding air. When the relative humidity changes, a difference in the vapour partial pressure results in the material absorbing or desorbing moisture in order to reach equilibrium. Due to their properties hygroscopic materials have lots of applications in different fields of industry. Typical hygroscopic materials being utilized in industry are, among others, wood, wood-plastic composites, some plantae based material, and for instance concrete.

Increased environmental consciousness has led to the market to look for more sustainable options. Among others, materials that are not refined using toxic chemicals enable companies to build more responsibly and make disposal convenient when needed. Wood as an natural, substantially long-lasting hygroscopic material offers an attractive and cost-effective solution to these environmental sustainability related demands. However, up to 80% of harvested wood in the developing world is presently going to waste or being burned. Especially, less than 5 percent of tropical forests are being managed sustainably.

The present wood-processing methods, such as traditional drying and compressing processes to form hardwood have not provided economically attractive solutions enough for investors to increase the proportion of the harvested wood being used in producing sustainable wood-products such as buildings and furniture. Particularly, some lower-grade tropical wood species have been considered unsuitable for such applications since it has not been possible to reach the level of quality meeting requirements relating mechanical properties as well as dimensional accuracy and surface quality of such products. Also the process delivery cycle in many cases is far too long for these and also some higher grade wood species when the state of the art drying and compressing processes are used.

Thermomechanical modification processes, such as Thermomechanical Timber Modification (TMTM) process for example, allows utilization of larger degree of the harvested wood material. With the thermomechanical modification process the characteristics, such as compression strength and stiffness, density, hardness and dimensional stability for example, of the hygroscopic material can be modified to be suitable for the specific application of the material. One known thermomechanical modification process is disclosed in publication WO 2022/175585 A1.

The effective and optimal control of the modification processes, such as the above mentioned thermomechanical modification process for example, however, is problematic, due to the high amount of factors affecting the processes.

### SUMMARY

The aim of the present invention is to achieve a new method for controlling a modification process of hygroscopic materials, which remarkably shortens the process delivery cycle of process, and which also improves the level of quality achieved for modified hygroscopic materials. Especially, the aim of the present invention is to form a method for controlling a modification process of hygroscopic material so that such quality parameters as strength of material, surface hardness and dimensional stability of the modified hygroscopic material is significantly improved while the process delivery cycle is remarkably reduced.

The aim of the invention is reached because with the method for processing hygroscopic material according to the invention a modification process for modification of the hygroscopic material is controlled by using genetic algorithms and genetic programming on the basis of at least one intermediate parameter calculated by a neural network by using at least one measured process variable of the modification process and at least one measured process variable of the hygroscopic material as input parameters for the neural network, and because neural network is learned to take into account case by case non-linear dependencies of the different input parameters depending on the material and its initial state as well as desired properties to be achieved for the end product.

The measured process variables of the modification process include, but are not limited to: air temperature, air speed, air relative moisture content, air pressure, compression force, and compression speed, for example.

The measured process variables of the hygroscopic material include, but are not limited to: moisture, temperature, moisture gradient, occurring of micro cracks, size of the pieces to be modified, and compression (thickness), for example.

Also other suitable additional input parameters for the neural network may be used.

Preferably, the modification process controlled with the method of the present invention is a thermomechanical modification process of hygroscopic material. Further, in the method of the present invention the moisture gradient of the hygroscopic material is preferably measured by electrical impedance spectroscopy (EIS), and the occurring of micro cracks in the hygroscopic material is preferably monitored by acoustic emission (AE).

More precisely, the method according to the invention is characterized by what has been presented in the independent claim 1 and apparatus according to the invention is characterized by what has been presented in the independent claim 15. The dependent claims 2-14 present some advantageous embodiments of the method according to the invention.

The advantage of the method and apparatus according to the invention is that by the method and apparatus according to the invention the affecting factors, such as values of moisture gradient and amount of micro cracks, in a hygroscopic material during its modification can be kept within the acceptable level and thus appropriate overall quality for such modified hygroscopic material is reached even the process delivery cycle is remarkably shorter than before. Especially, the ability of the hygroscopic material to absorb moisture from the air and the strength of the material is enhanced. For that reason, due to the invented new method and apparatus hygroscopic materials such as low-grade tropical wood species can be used in more sustainable applications e.g.

in furniture or building products instead that they would be burned or dumped as it mostly happens today.

Furthermore, genetic algorithm and genetic programming provides in this kind of application further advantages by solving many different problems in controlling the modification process which have not been solved by the present control methods. These are, among others;
In drying phase monitoring techniques are of use only when the mutual and total effects of the observed process values on changes in the properties of the material to be dried are known,
Hygroscopic materials, such as wood are usually inhomogeneous natural materials and there are thousands of species, all with different physical properties. Thus, each of them have own specific characteristic which should be taken into account when these are processed to reach end product having desired properties,
When the goal is to modify even approximately certain physical properties (surface hardness, strength, moisture, torsional stiffness, age resistance without chemical, environmentally harmful substances), the task forms theoretical optimization situation to which genetic algorithm (GA) and genetic programming (GP) methods and suitable on-line measurement technology provides more effective tools than traditional methods wherein some single predetermined, mathematical model based control program is used.

### BRIEF DESCRIPTION OF THE DRAWINGS

Next the invention is described in more detail by referring to the attached drawings wherein

FIG. 1 shows schematically a cross-section of a modification chamber of a modification apparatus being applied in an embodiment of an apparatus according to the invention, and

FIG. 2 illustrates an embodiment of an artificial neural network for use in the present invention.

FIG. 3 shows a flow chart of an embodiment of the method according to the invention.

### DETAILED DESCRIPTION OF SOME ADVANTAGEOUS EMBODIMENTS OF THE INVENTION

In the method according to the invention a modification process of hygroscopic material, such as a thermomechanical modification process for example, is controlled. In such thermomechanical process hygroscopic material such as wood is treated in a modification apparatus which typically has a modification chamber into which hygroscopic material is transferred and wherein the hygroscopic material is modified by applying a process which includes several process phases such as moisturizing, drying, heating and compression. Thus, atmospheric conditions in the modification chamber such as air temperature, air relative moisture content as well as e.g., compression force are altered according to a control program applied. Thus, the procedure being used depends on, among others, the type and quality of hygroscopic material before modification, size of the pieces to be modified as well as the desired appearance and mechanical properties to be achieved for the hygroscopic material in the modification. After the desired properties for the hygroscopic material to be handled is reached it will be transferred outside the modification chamber for further processing such as packing, storing and/or transporting to an another inhouse manufacturing department or to the end users of the material.

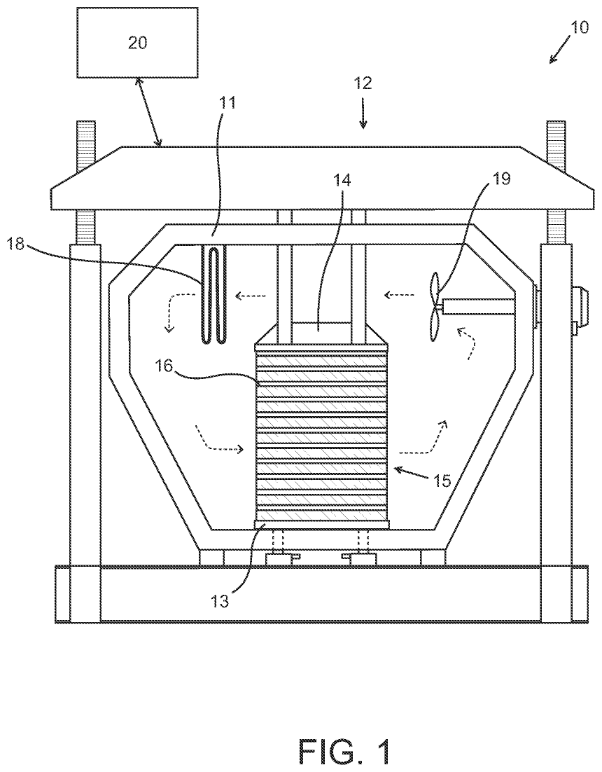

An example of such modification apparatus 10 is shown in the FIG. 1. It comprises a modification chamber 11 in to which the hygroscopic material 15 can be placed when it is thermomechanically modified. In this example, hygroscopic material to be modified is in form of a batch i.e., it includes plurality of pieces of such material which have been placed adjacent to each other and/or one on the other such a way that there may be or may not be one or more intermediate pieces in between each or some rows and/or columns of the pieces of the hygroscopic material. These intermediate pieces 16 are preferably cell-like boards, plates or stickers having hollow spaces or channels through which air being blown in the modification chamber can flow.

The hygroscopic material to be modified in the modification apparatus 10 shown in the FIG. 1 may be, for instance, wood, wood-plastic composites or some plantae based material. Preferably, these materials are such that they behave corresponding manner than wood when they are modified.

In the modification chamber 11 there is a compressing device 12 which has a first compressing member 13 and a second compressing member 14 between which the batch of the hygroscopic material 15 to be modified is placed and by means of which it can be compressed during the modification. The first compressing member 13 and the second compressing member 14 are platform-like elements which have flat compressing surfaces between which the material to be modified can be placed when it is modified. In this embodiment the compression device has only two compressing members and thus it can be applied for compressing the material to be modified in thickness direction of the pieces of the hygroscopic material. However, the compressing device may have, in this and in some other embodiments of the method and apparatus, also further compressing members for compressing the pieces of the hygroscopic material also in other directions i.e. in width and/or length directions.

There are also heating means 18, blowing means 19 as well as moisturizing means (not shown in the figure) in the modification chamber 11 of the modification apparatus 10 shown in the FIG. 1. The heating means 18 may be e.g. an electric heater, oil heater, or suitable biofuel heating device. The blowing means 19 is preferably electric operated fan, and the moisturizing means may comprise liquid-spraying and/or steaming devices or apparatuses.

The modification apparatus 10 shown in the FIG. 1 comprises also measurement means for measuring different properties of the hygroscopic material. Especially, when applying the method according the present invention, moisture gradient of the hygroscopic material to be modified is preferably measured by means of electric impedance spectroscopy (EIS), and amount of microcracks in the hygroscopic material preferably by acoustic emission (AE). Also other type of sensors and measurements may be used to define the moisture gradient and amount of micro cracks. These measurements are made at least during the thermomechanical modification, but can be made also before and/or after thermomechanical the modification. On-line measurements may be arranged by providing suitable sensors which are connected to the control unit 20 of the modification apparatus 10 e.g., wirelessly by means WLAN network or some other suitable wireless data communication technology. Alternatively wired connections may also be used.

Also, some other process parameters and physical quantities, such as temperature, moisture content of the air and/or the hygroscopic material to be modified as well as weight of the hygroscopic material to be modified in the modification apparatus 10 may be measured by using suitable measuring sensor technology. There may be on-line measurement equipment/sensors as well as testing devices/instruments available in connection with the modification apparatus 10. Also separate laboratory measurements can be applied for verification of the determined values of the properties. The laboratory measurements are most preferably applied for such properties of the hygroscopic material as moisture content, hardness and strength of the material. The control unit 20 to which the on-line measurement means are connected and/or to which the additional input data is fed, is arranged to control the different devices of the modification apparatus such as compressing device 12, heating means 18, blowing means 19 and moisturizing means according to control program being executed in the control unit 10. Thus, the control unit 20 includes computation means to execute the control program and a memory in to which the control programs and the data being processed is saved. Therefore, the computation means has ability to control these devices such that the method according to the invention may be carried out i.e., it has programs for run the neural network as well as the genetic algorithms and genetic programming to carry out data processing according to the method of the present invention. Control unit may have also required electronic circuits and components to control the actuators, such as fans and actuators of the compressing device, and measurement devices of the modification apparatus to control them so that modification process carried out by the modification apparatus can be controlled fully automatically by the control unit 20.

Thus, the above-mentioned control program in the control unit 20 controls the thermomechanical modification process of hygroscopic material according to the method of the invention. The method in this embodiment comprises at least the following method steps;
measuring temperature and moisture in the modification chamber,
measuring moisture gradient of the hygroscopic material preferably by electrical impedance spectroscopy (EIS) at least during the modification;
monitoring amount of micro cracks occurring in the hygroscopic material preferably by acoustic emission (AE) at least during the modification,
calculating at least one intermediate control parameter by a neural network by using at least the measured variables as input parameters of the neural network,
controlling the thermomechanical modification process by using genetic algorithms and genetic programming based on the said at least one intermediate control parameter determined by the neural network.

Electrical impedance spectroscopy (EIS) refers to the measurement of the impedance (alternating current resistance) of an object at several frequencies. The result is a frequency spectrum that provides information about the structure and properties of the object. Impedance spectroscopy has been used in various applications, one of the most important of which is the study of biological matter, for example in medicine. In the present invention EIS technology is used to monitor the structure and moisture distribution and gradient of hygroscopic material in real time.

Electrical impedance spectroscopy measurement arrangement may include suitable electrodes which are placed on the surface of the material to be measured and by means of which the impedance measurements are carried out during the modification. There may be separate measurement device with the electrodes inside the modification chamber which is then wirelessly connected with the control unit 20 of the modification apparatus.

Acoustic emission (AE) may be used to monitor microcracking that may occur during drying. If such hygroscopic material as wood is exposed to cracking during its drying, the first phenomenon to be observed is micro-cracking. Material emits sound from ultrasonic frequencies during micro-cracking. By monitoring the acoustic emission and adjusting the modification process accordingly, macro-cracking detrimental to the end product quality can be eliminated.

Acoustic emission measurement arrangement may comprise e.g. piezo-electric sensors which measures the ultrasonic sound waves formed by the micro-cracking of the hygroscopic material to be monitored. Sensor may be wirelessly connected with the control unit 20 to provide measurement data accordingly.

Genetic algorithms are heuristic optimization methods that mimic the evolutionary mechanisms of nature. They are suitable for tasks where the solution space is very large (e.g., large combinatorial problems) and even the approximate optimum is sufficient for the solution. With the rapid growth of computing capacity in computers, the application possibilities of genetic algorithms have expanded greatly over the past decade.

Genetic algorithm (GA) and genetic programming (GP) as a method of regulation and control of the thermomechanical modification process improves quality of the end product. This is because traditional mathematical analysis does not or cannot provide an analytical solution. GA and GP as adaptive methods adapt to changes in the modification process. The process becomes better without outside intervention through real-time optimization or machine learning. Adaptation is continuous. Presently the internal relationships between the relevant variables are poorly understood (or where there is reason to suspect that the current understanding is incorrect). Finding the size and shape of the last solution to a problem is an important part of the problem. An approximate solution is acceptable (or is the only solution likely to ever be reached). In such tasks there a lot of computer-readable data is encountered that requires review, classification, and aggregation. Small improvements in performance are routinely measured (or easily measurable) and are significant to the overall outcome.

Furthermore added value of genetic algorithm and genetic programming in measurement and control technology of the thermomechanical modification process is that when drying the hygroscopic material during the thermomechanical modification process, the priority is not to control the humidity and temperature of the air, but that the hygroscopic material to be dried is not damaged as a result of drying and that the final moisture of the dried hygroscopic material is sufficiently even, the material has a low moisture gradient. Processed hygroscopic material with an intact structure and the lowest possible moisture distribution, gradient and desired moisture content is achieved.

To achieve this and other goals of the method, the EIS and AE monitoring methods presented above make it possible to detect in real time the time and conditions at which the damage to the tree begins. When the time and circumstances are known, efforts can be made to avoid such situations. This makes possible to create conditions for hygroscopic material to not crack or damage.

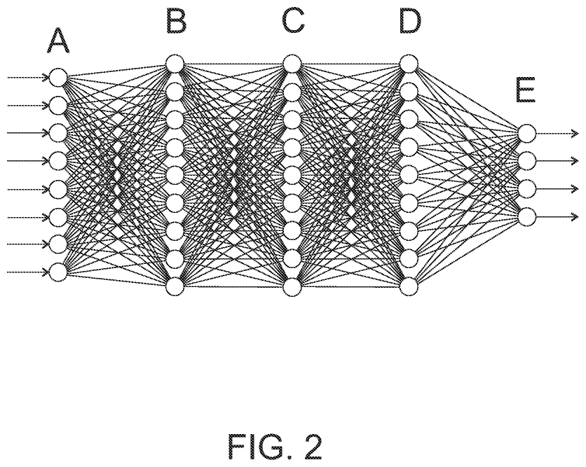

Artificial neural network (hereinafter “neural network”), and embodiment of which is illustrated in FIG. 2, is a non-linear statistical data modelling or decision making tool. It can be used to model complex relationships between inputs and outputs or to find patterns in data. It involves a network of simple processing elements (artificial neurons) which can exhibit complex global behaviour, determined by the connections between the processing elements and element parameters. In the present invention neural network is applied in determining relationships between properties of the hygroscopic material and measured moisture gradient and micro-cracks as well as other measured quantities of the hygroscopic material to be modified.

In the embodiment of FIG. 2, the measurable input data for the input layer A may comprise, but are not limited to: initial moisture content of the material; process temperature; relative humidity; steam consumption; moisture content gradient; weight and/or density of the material; micro cracking; wood species; compression pressure, rate and/or speed; air velocity and/or direction; and/or changes in the input values.

In the neural network the complex relationships are defined by the hidden layers B-D, i.e. the deep learning stage, between the input data and the output data from the output layer E, which output data may comprise, but is not limited to: colour gamut; hardness; strength; modulus of elasticity (MOE); modulus of rupture (MOR); compression; density; dimensional stability; fire resistance; decay resistance; fungi resistance; termites resistance; process sensors' temperature/humidity calibration and compensation.

Intermediate control parameters may be values of moisture gradient and microcracking which have been calculated by using the neural network on the basis of initial state of the hygroscopic material to be modified. They may be also some other values and/or combination of values which have been calculated by using the neural network and which then is used as input values for genetic algorithm to be used in control of the modification apparatus.

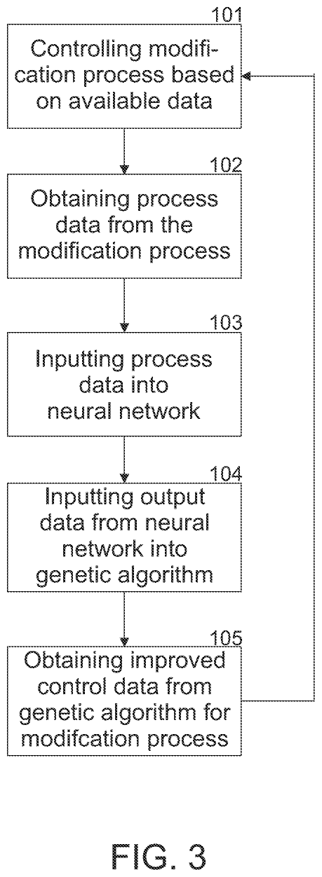

A flow chart of an embodiment of the method according to the present invention is shown in the FIG. 3.

In the embodiment of FIG. 3, the modification process of hygroscopic material is controlled based on available data, as shown in box 101. At start of the modification process this data may be based or comprise measurable variable relating to the processed material, such as moisture content, weight, density, wood species, for example, and the process itself, such as process temperature, air velocity, compression pressure, for example.

During the modification process, data relating to the process is collected with suitable sensors and measurements, as shown in box 102.

The obtained process data is used as input data for the neural network, as shown in box 103. Then the output data from the neural network is used as input data for genetic algorithm, as shown in box 104.

Improved control data for the modification process is obtained from the genetic algorithm, as shown in box 105, which is then used for controlling the actual modification process as shown in box 101.

The process shown in FIG. 3 can be implemented a plurality of times until the required quality and characteristics of the modified hygroscopic material are obtained with the modification process.

An embodiment of the method of the present invention may further comprise determining expected values for the moisture gradient and the amount of micro cracks, and teaching the neural network and controlling the modification process to achieve measured values of the moisture gradient and the amount of micro cracks being as near as possible to the expected values of the moisture gradient and the amount of micro cracks (i.e., values that have been calculated by using neural network).

An embodiment of the method of the present invention may further comprise determining initial state of the hygroscopic material to be modified. Determining initial state of the hygroscopic material is meant determining its properties such as initial moisture content, initial moisture gradient, initial amount of microcracks before modification. These can be determined by suitable investigations and/or measurements. Measurements to determine initial state of the hygroscopic material can be carried out before modification as laboratory measurements or in the modification chamber before start of the modification by using online measurements. Knowing the initial state of the hygroscopic material to be modified will improve and speed up the process as well as prevent situations where the control program does not reach the best possible results because of deviation of the expected initial state from actual initial state of the hygroscopic material.

An embodiment of the method of the present invention may further comprise determining occasional control values and parameters. Case by case some hygroscopic materials may include values of parameters that may deviate from usual values. Some hygroscopic materials may also have characteristic or behaviour due to which its modification needs to have some additional parameters to be used in controlling the process. In such case these parameters or values can be determined before starting the process or during the process, for instance when some triggering individual value of an ordinary parameter or combination of several values of the ordinary parameters have been obtained.

An embodiment of the method of the present invention may further comprise drying of the hygroscopic material by using functions of the problem, variables, and parameters. Functions of the problem can be functions which are provided for mathematically calculation relationships between the measured or monitored parameters, such as moisture gradient and amount of microcracks in view of used atmospheric conditions in the modification chamber or pressing force of the compressing device.

An embodiment of the method of the present invention may further comprise evaluation of the dried hygroscopic material. Evaluation of the dried hygroscopic material may comprise e.g., detection of the surface quality and dimensional accuracy of the pieces (such as straightness) of the hygroscopic material, measurement of the strength and/or hardness, or determining moisture content of the dried hygroscopic material.

An embodiment of the method of the present invention may further comprise creation of a new control program being based on the data obtained from previous phases. In development of the new control program results of the calculations by neural network may be utilized to have a control program that reacts to the changes in the measured parameters according to some desired properties that is sought for that specific hygroscopic to be modified. Thereby, the modification process can be controlled in a way that provides most suitable properties for that hygroscopic material for its intended use.

An embodiment of the method of the present invention may further comprise copying the best existing control program. Copying the best existing control program speeds up the computation in the control unit 10 since, of course if the start point is chosen more properly it decreases amount of different phases and calculation required to reach the optimal results by using the predetermined intermediate parameters.

An embodiment of the method of the present invention may further comprise creation of new control program by mutation. Mutation involves substitution of some random part of a program with some other random part of a program. Thus, in this embodiment iteration is used to test different combinations of substitutions to find as good solution as possible for the case in question.

An embodiment of the method of the present invention may further comprise creation of new control program by crossing. When the desired properties for the modified hygroscopic material is somewhere in between two or more existing control programs suitable control program may be achieved by combination of the features of such existing control programs. Thus, by applying crossing in such cases surely leads quicker to a suitable control program by using less calculation than in case the start point would be some single existing control program that is further away from the final solution than some combination of two or more existing programs already containing all or at least most of the necessary features.

An embodiment of the method of the present invention may further comprise choosing the best control program being appeared in any population and using that control program in controlling the modification process. Such method step is done for finding optimal solution for each specific case in application of genetic programming. As it can be understood, there are several different combinations of features which can be achieved for some particular hygroscopic material. In addition there are several different kinds of hygroscopic materials as well as usually number of applications for such materials. Thus, there are huge amount of different combinations of control parameter combinations which would be the best ones for all these different goals. Thus, the results that have been achieved by different control programs need to be evaluated and placed in order of their suitability and then to make choice which one of the evaluated alternatives gives best results for that particular product by using the hygroscopic material that have been chosen for its raw material.

An embodiment of the method of the present invention the amount of water in the hygroscopic material is determined. The amount water in the hygroscopic material may be determined by a microwave resonator or by measuring initial weight of the hygroscopic material and that during the modification process as described e.g., in the applicants earlier application publication WO 2022/175585 A1.

In an embodiment of the method of the present invention the amount of water in the hygroscopic material is taken account in calculating the at least one intermediate control parameter by the neural network. The amount water in the hygroscopic material have effect on the modification process through the moisture gradient to be determined at least during the modification process. Thus, if the amount of water in the hygroscopic material is known it is easier to predict the changes in the moisture gradient and amount of micro cracks occurring in the hygroscopic material which are the main parameters describing the state of the hygroscopic material to be optimized during its modification in the present method.

In some other embodiments of the method of the present invention there may be present also other quality parameters than moisture content, moisture gradient and amount of micro cracks. For instance, in case when compression is applied in the modification, density of the pieces which are treated may be determined, by measuring the volume and weight of the pieces. By such additional control parameters controlling of the modification process, the process can be further improved, and especially fitted suitable for more specific uses and applications.

The method and apparatus for controlling modification process of the present invention is not limited to the above described embodiments, but they can be varied within the scope of the claims. In further embodiments, one or more of the above described embodiments can be combined to have suitable combination to reach desired properties to the hygroscopic material to be modified.

1. A method for controlling a modification process of hygroscopic material comprising method steps of:
measuring at least one process variable from the modification process at least during the modification;
measuring at least one process variable from the hygroscopic material at least during the modification;
calculating at least one intermediate control parameter by a neural network by using at least the measured process variables as input parameters of the neural network;
controlling the modification process by using genetic algorithms and genetic programming based on the said at least one intermediate control parameter determined by the neural network.

2. The method of claim 1, wherein the modification process is a thermomechanical modification process, and/or the at least one measured process variable from the hygroscopic material is moisture gradient and/or occurring of micro cracks.

3. The method of claim 1, wherein the method comprises determining expected values for the measured process variables, and teaching the neural network and controlling the modification process to achieve measured values of the process variables being as near as possible to the expected values of the process variables.

4. The method of claim 1, wherein the method comprises determining initial state of the hygroscopic material to be modified.

5. The method of claim 1, wherein the method comprises determining occasional control values and parameters.

6. The method of claim 1, wherein the method comprises drying of the hygroscopic material by using functions of the problem, variables, and parameters.

7. The method of claim 6, wherein the method comprises evaluation of the dried hygroscopic material.

8. The method of claim 1, wherein the method comprises creation of a new control program being based on the data obtained from previous phases.

9. The method of claim 1, wherein the method comprises copying the best existing control program.

10. The method of claim 1, wherein the method comprises creation of new control program by mutation and/or by crossing.

11. The method of claim 1, wherein the method comprises choosing the best control program being appeared in any population and using that control program in controlling the modification process.

12. The method of claim 1, wherein the amount of water in the hygroscopic material is determined.

13. The method of claim 12, wherein the amount of water in the hygroscopic material is taken account in calculating the at least one intermediate control parameter by the neural network.

14. The method of claim 12 wherein the amount water in the hygroscopic material is measured by a microwave resonator.

15. An apparatus for controlling a modification process of hygroscopic material, the apparatus comprising: a control unit configured to control the modification process of the hygroscopic material by
measuring at least one process variable from the modification process at least during the modification;
measuring at least one process variable from the hygroscopic material at least during the modification;
calculating at least one intermediate control parameter by a neural network by using at least the measured process variables as input parameters of the neural network;
controlling the modification process by using genetic algorithms and genetic programming based on the said at least one intermediate control parameter determined by the neural network.
